(19) United States
(12) Patent Application Publication
(10) Pub. No.: US 2002/0161072 A1
(43) Pub. Date: Oct. 31, 2002

(54) Wood fiber-filled polypropylene

(76) Inventors: Philip Jacoby, Marietta, GA (US); William H. Crostic, Sugar Hill, GA (US); Richard G. Sullivan, Roswell, GA (US)

Correspondence Address: BP Amoco Corporation, Docket Clerk, Law Department, M.C. 2207A, 200 East Randolph Drive, Chicago, IL, 60601-7125, US

(21) Appl. No.: 09/766,810

(22) Filed: Jan. 22, 2001

(51) Int. Cl. C08J 3/00

(52) U.S. Cl. 524/27

(57) ABSTRACT

Compositions comprising highly crystalline propylene polymer having an nmr tacticity index of at least 94, wood fiber, and, optionally, a functionalized olefin polymer such as maleated polypropylene exhibit substantial improvement in resistance to moisture and excellent creep properties, particularly at elevated temperatures. Such compositions are particularly useful in providing extruded outdoor building components such as decking.

This invention relates to rigid, strong, cellulose fiber-filled olefin polymers and particularly to compositions comprising high crystalline, high tacticity, propylene polymers filled with natural cellulose fiber. Still more particularly, the invention relates to wood fiber-filled polypropylene compositions having improved stiffness, strength and creep resistance and to fabricated articles comprising such compositions, including methods for the fabrication thereof.

Filled compositions according to the invention may be particularly useful in the fabrication of wood decking planks, structural components and the like.

### BACKGROUND OF THE INVENTION

Wood has long been a highly desirable material for use in a wide variety of structural and decorative uses. Wood is readily fabricated using a variety of shaping techniques, and—when properly selected—has adequate strength, rigidity and toughness to meet the demands of a wide variety of applications.

However, in use, wood also exhibits a number of deficiencies. It is subject to attack by insects, fungus, and mold. In exterior applications, wood needs to be repeatedly and systematically treated or painted to protect it from the elements. Further, wood is dimensionally unstable; it tends to absorb and lose moisture under ambient conditions of use and thus undergo substantial dimensional change. Even when well-protected and maintained, wood may warp, splinter and deteriorate by cracking, checking or the like. Wood of high quality, free of knots and having a uniform grain is expensive, and reliable sources of such wood have become difficult to find.

Common plastics have found limited use as a wood substitute in many structural applications. As a building material, for example as decking, plastics have a number of advantages including being extrudable, recyclable and environmentally friendly. Plastic components do not splinter, rot, or crack in use. However, plastics, and particularly low cost polyolefins, have a substantially lower modulus of elasticity than wood, thus lacking the stiffness required for many uses. Though filled resins, and particularly glass fiber-filled polyolefins, have adequate rigidity to serve as wood substitutes, filled compositions tend to be somewhat brittle, with lower strength properties, and may be too costly to become widely accepted in many building applications.

Recently, olefin plastics have been blended with cellulosic materials to provide composites that combine many of the advantages of wood and of plastic. Cellulose fiber-plastic composites may be fabricated using standard extrusion and molding equipment and techniques to provide decking components, trim, fascia board and the like with stiffness characteristics approaching or surpassing those of wood components, while being available at an acceptable cost. Cellulose-filled polyethylene HDPE resins are extruded commercially to produce boards of virtually any length having popular nominal lumber sections and dimensions. Trim, handrail, baluster, casing components and the like are also produced from these compositions by profile extrusion. However, because these compositions have a lower modulus of elasticity than wood lumber and thus are more flexible, the boards are not used as joists, beams, studs, columns or stringers. Additionally, metal or wood reinforcement is recommended for extruded railing and the like when used for balcony application and similar off-the-ground uses.

Where outdoor use during the summer or in southern climates is contemplated, the high temperature properties of the filled resin formulation become an important factor. Filled polyethylene resin formulations are lacking in strength and rigidity at moderately elevated service temperatures. Moreover, such formulations exhibit poor performance under load, undergoing excessive creep and failing through creep rupture in a relatively brief test period. Cellulose-filled propylene homopolymer and copolymer resin formulations have been disclosed as lumber replacement for use in applications where greater rigidity is desired, particularly at elevated temperatures.

Even though wood fiber-filled resins may have certain economic advantages, it is difficult to provide formulations with adequate rigidity and strength that are processable using low cost melt extrusion fabrication methods. Propylene polymers and similar high melt-temperature resins generally require increased processing temperatures. These resins typically have a lower melt index than polyethylene resins and, when filled, the melt index is further reduced, the amount of lowering depending in part upon the level of filler. Materials with low melt index require special attention during extrusion, lest the longer residence times and increased shear cause thermal decomposition or other degradation. Raising the extruder temperature may serve to overcome the low melt index of the composite, but this too can cause thermal decomposition of the resin and thermal degradation or “burning” of the cellulosic fiber component. Adding a minor amount of amorphous, highly atactic polypropylene is disclosed in the art to be useful for improving the melt index of cellulose-filled polyolefin compositions, however, adding amorphous polypropylene in an amount sufficient to adequately improve melt flow also tends to lower the rigidity.

An important consideration for use of wood and wood substitutes in decking and other outdoor applications is the effect of moisture on properties. Cellulose-filled plastics, particularly polyolefin compositions containing very high levels of wood flour or other cellulosic fiber, tend to absorb moisture. Although filled HDPE resin formulations exhibit good dimensional stability in wet environments, strength properties are reduced as the water content increases. This occurs in part because water reduces the adhesion between the wood cellulose filler and the polyolefin. Methods known in the art for improving filler-resin adhesion and thereby increasing the strength and rigidity of the filled resin include adding maleic anhydride-modified polyolefins such as maleated polypropylene. Ethylene-alkyl acrylate-maleic anhydride terpolymers have also been employed for this purpose. The further addition of a drying agent such as calcium oxide, particularly when used in combination with low molecular weight maleic anhydride-modified polypropylene, has been disclosed to overcome the moisture content of the filler and thereby improve the rigidity of wood-filled polyolefin resins. These additives and processes improve the initial strength properties of extruded and molded products. However, the strength properties of such lumber and decking components substantially deteriorate in extended outdoor use, particularly in wet environments.

Wood-filled polyolefin composites having improved stiffness, particularly at elevated temperatures, together with good creep resistance and increased resistance to moisture are clearly needed by the art. Extruded decking and lumber improved in strength and rigidity could be used over wider unsupported spans. Such lumber may also permit limited use as structural components, for example, in railing or the like without the need for added metal or wood reinforcement. Moisture resistant formulations could find wide application in fabricated lumber and building components including trim, decking and the like intended for outdoor use, particularly in warm and even tropical environments.

### SUMMARY OF THE INVENTION

This invention is directed to improved polymer compositions comprising a highly crystalline, high tacticity propylene polymer and cellulose fiber filler. Preferably the filled compositions of this invention comprise a highly crystalline propylene polymer having an NMR tacticity index of at least 94, a cellulosic fiber, and a functionalized olefin polymer in an amount sufficient to improve compatibility between polymeric materials and the fiber.

The invented compositions are useful in the manufacture of extruded plastic lumber for use in a variety of applications including decking, trim, outdoor structures, garden furniture and the like; hence, the invention is further directed to extruded lumber and decking components and to a method for making such components. The invention may also be viewed as directed to a method for making molded articles and extruded goods comprising wood-filled, highly crystalline, high tacticity polypropylene formulations.

As used herein, the term “amount sufficient to improve compatibility” means an amount of functionalized olefin polymer that will provide articles having increased strength properties compared with articles fabricated from compositions lacking such functionalized polymer.

### DETAILED DESCRIPTION OF THE INVENTION

The improved polymer compositions according to this invention are filled polymers comprising a highly crystalline propylene polymer having an nmr tacticity index of at least 94 and a molecular weight distribution of about 7 to 15 and a stiffness-enhancing amount of cellulose fiber. Preferably, the compositions will further include a compatibilizing aid such as a functionalized olefin polymer in an amount sufficient to improve compatibility between the polymer and fiber components.

Polymers of propylene having substantial polypropylene crystallinity content now are well known in the art. It has long been recognized that crystalline propylene polymers, described as “isotactic” polypropylene, will contain crystalline domains interspersed with some non-crystalline domains. Noncrystallinity can be due to defects in the regular isotactic polymer chain that prevent perfect polymer crystal formation. The extent of polypropylene stereoregularity in a polymer can be measured by well-known techniques such as isotactic index, crystalline melting temperature, flexural modulus and, recently, by determining the relative percent of meso pentads (% m4) by carbon-13 nuclear magnetic resonance (¹³C NMR). The highly crystalline polypropylene component of the invented compositions will generally have an NMR tacticity index greater than 90, preferably greater than about 94, and still more preferably in a range of about 94 to about 97. Polypropylenes having a still higher tacticity index, to as great as 100 will be found useful. For comparison, general purpose propylene polymers typically have an NMR tacticity index up to about 92, while high crystalline propylene polymers having NMR tacticity indices above about 94 have more recently become available.

The propylene polymers especially useful in the practice of this invention will have both a high NMR tacticity and broadened molecular weight distribution (MWD) as measured by the ratio of the weight average to number average molecular weights (Mw/Mn). Such molecular weights typically are measured by gel permeation chromatography (GPC) techniques known in the art. The MWD will preferably lie in the range of from about 7 to about 15, more preferably from about 8 to about 12. A typical propylene polymer useful in this invention has an MWD of about 10.

Polypropylene (PP) resins may also be characterized by Melt Flow Rate or MFR; generally, molecular weight is inversely related to MFR. As used herein, MFR is given in g/10 min., determined according to ASTM D1238, Condition L, i.e. using a 2.16 kg load at 230° C. The crystalline, isotactic polypropylene component of the invented composition will typically have an MFR of about 0.4 to about 100, preferably about 2.5 to about 65, and most preferably from about 5 to about 40 g/10 min.

Particularly useful highly crystalline, broad molecular weight distribution propylene polymers can be produced using the process described in U.S. Pat. No. 5,218,052, incorporated by reference herein.

Propylene polymers having the requisite crystallinity and MFR made by other methods including those known in the art for the manufacture of olefin polymers employing metaliocene catalysts may also be found useful in providing cellulose fiber-filled compositions as described herein.

The high crystalline polypropylenes useful in the practice of this invention exhibit enhanced flexural modulus and heat deflection temperatures. The flexural modulus of these materials, which have been nucleated, typically ranges from about 250 to about 400 kpsi (1700-2800 MPa) (ASTM D790) and preferably from about 275 to 350 kpsi (1900-2400 MPa). Most preferably, the flexural modulus is at least 300 kpsi (2000 MPa). The flexural modulus for unnucleated materials generally is about 10% less than for nucleated materials. Heat deflection temperature (ASTM D648 at 66 psi (455 kPa)) typically ranges from about 2350 to 2850 F. (112°-140° C.) and preferably from about 250° to 275° F. (120°-135° C.).

As set forth in the art, a crystallization nucleating agent may be provided to increase the number of crystallization nuclei in the molten polypropylene, thereby increasing the crystallization speed and promoting crystallization from the melt, solidifying the resin at a higher temperature. Generally, molten, non-nucleated polypropylene will begin crystallizing upon cooling to a temperature around 120° C., with a peak in crystallization rate near 110° C. Nucleated polypropylene resins may start to crystallize at temperatures as great as about 135 to 140° C., with a peak around 130° C. The crystallization nucleating agent will generally be used in an amount of from about .01 to about 0.5 wt. %, preferably from about 0.05 to about 0.3 wt. %. Examples of such agents disclosed in the art and employed for improving the crystallization speed include organic sodium phosphates such as sodium bis(4-tert-butyl-phenol) phosphate, sodium benzoate and mixtures comprising a monocarboxylic aromatic acid or a polycarboxylic aliphatic acid and a silicate or an alumino-silicate of an alkali or alkaline earth metal. Sorbitol, dibenzilidene sorbitol and related compounds have been described in the art as networking agents for use in modifying the low shear melt viscosity and low shear melt strength of polyolefins. The use of organic sodium phosphates as crystallization agents is also disclosed in the art, for example in U.S. Pat. No. 4,596,833.

PP resins are initially produced in powder form. The resin powder may be blended with additional components according to the invention and used directly in the production of molded and extruded goods, or may be first compounded and pelletized according to methods commonly employed in the resin compounding art. For example, dried resin may be dry blended with such stabilizing components, nucleating agents and additives as may be required, then fed to a single or twin screw extruder. The polymer, extruded through a strand die into water, may then be conveniently chopped to form pellets and stored for subsequent blending to provide the invented blends for further fabrication.

The filled compositions of this invention typically contain from about 30 to about 85 wt. % high crystalline propylene polymer and preferably contain about 35 to 80 wt. % high crystalline propylene polymer. Most preferably, products of this invention contain about 40 to about 70 wt. % high tacticity propylene polymer. Compositions comprising about 40 but less than about 70 wt. %, preferably less than about 65 wt. %, may be still more preferred. Suitable highly crystalline polypropylenes are available commercially from BP Amoco Polymers, Inc. under the tradename ACCPRO.

The product of this invention may also include a compatibilizing aid to promote and improve adhesion between the propylene polymer matrix and the cellulose fiber filler. As used herein, the term “compatibilizing aid” means any material which can be mixed with polypropylene and cellulose fiber in accordance with the invention to promote adhesion between the polypropylene matrix and the fiber. The compatibilizing aid preferably will comprise a functionalized polymer, which may be further described as a polymer compatible with the propylene polymer matrix and having polar or ionic moieties copolymerized therewith or attached thereto. Typically, these functionalized polymers are propylene polymers grafted with a polar or ionic moiety such as an unsaturated carboxylic acid or anhydride thereof, for example, (meth)acrylic acid, maleic acid, fumaric acid, citraconic acid, itaconic acid or the like. The propylene polymer portion of the graft copolymer may be a homopolymer of propylene or a copolymer of propylene with another alpha-olefin such as ethylene; a homopolymer of propylene is preferred. Functionalized propylene polymers suitable for the purposes of this invention include maleated polypropylene with a maleation level of from about 0.4 to about 2 wt. %, preferably 0.5-1.25 wt. %, and a melt index (Ml) of from about 1 to about 500, preferably from about 5 to about 300 g/10 min., determined at 190° C. and 2.16 kg. A particularly suitable maleated polypropylene is available under the tradename Polybond™ 3200 from Uniroyal. Other grades of Polybond™ resins may be found suitable, as may Fusabond™ maleated polypropylene resins from DuPont, Epolene™ modifier resins from Eastman Chemicals, and Exxelor™ modifier resins from Exxon Chemicals.

The functionalized polymer, when employed, will be incorporated into the product of this invention in an amount sufficient to act as a compatibility agent between polymeric materials and the cellulosic fiber. Typically, about 0.3 to about 12 wt. % of functionalized polymer is sufficient to provide adequate adhesion between the polymer matrix and the fiber component. Since the functionalized polymer is more expensive than the bulk high crystalline propylene polymer, there is an economic incentive to minimize the proportion of such functionalized polymer in the total product. Preferably, such functionalized polymer is incorporated into the product of this invention at a level of about 0.5 to 10 wt. % and most preferably at a level of about 1 to 6 wt. %, based on total weight of resin and filler components. Products containing from about 1 to about 4 wt. % functionalized polymer, especially maleated polypropylene, were found to be especially suitable.

The cellulosic filler employed in the practice of this invention may be obtained from a variety of natural sources including wood. Vegetable fibers from sources such as sugar cane, pulp, hemp, kenaf, flax and the like may also be found useful, as may pulverized peanut shells, cherry pit flour, and the like. Wood fiber in the form of wood flour is particularly suitable for the purposes of this invention, and is widely available from a variety of sources. The particle size of the cellulosic fiber, whether crushed or pulverized or in the form of screened fiber, is not particularly important to the practice of the invention. As is well known in the arts, particle size may affect processability as well as the physical properties of the resulting blend and thus will be selected according to principles well understood and widely practiced in the compounding arts to provide processable formulations with the desired degree of reinforcement.

Generally, the compositions of this invention will comprise from about 15 to about 70 wt. %, preferably from about 20 to about 65 wt. %, and still more preferably from about 20 to about 60 wt. % fiber, based on total combined weight of polymeric components and fiber.

In addition to the highly crystalline, high tacticity propylene polymer and cellulose fiber filler, and functionalized polymer if used, the compositions of this invention may further include other additives and components according to the art for improving processability, stability and appearance. Such further additives may include mineral fillers, for example, talc, as well as foaming agents, thermal stabilizers, plasticizers, ultraviolet light stabilizers, lubricants, mold release agents, flame retardants, colorants, dyes, pigments such as titanium dioxide and the like, and such other additives and components as may be desired, all according to common practice in the polymer compounding and molding arts.

The resin and filler components, and such other additives as may be used, may be blended and extruded according to well known and widely practiced methods and procedures with standard equipment commonly employed in the resin compounding arts. The invented polymer compositions will be further fabricated, for example, by melt extrusion to form decking, sheet, plank or board, extruded profile, trim goods and similar articles, or by injection molding, thermoforming or the like, using methods and practices commonly used in the plastics fabricating art.

The invention described herein will be better understood by consideration of the following examples, which are offered by way of illustration.

### EXAMPLE

Components used in preparing the formulations of the following examples include:

CPP-1: Highly crystalline propylene polymer, MFR=12, NMR tacticity index=96.1, MWD (Mw/Mn)=11, obtained as ACCPRO 9433 resin from BP Amoco Polymers, Inc.

CPP-2: Highly crystalline propylene polymer, MFR=35, NMR tacticity index=96.1, MWD (Mw/Mn)=9, obtained as ACCPRO 9934 resin from BP Amoco Polymers, Inc.

HPP*: Propylene homopolymer, MFR=35, obtained as 10-7944 from BP Amoco Polymers, Inc.

HPP: Propylene homopolymer, obtained as Solvay 1901 resin from Solvay Polymers Inc.

ICP*: Impact-modified propylene copolymer, MFR=20, obtained as 10-3541 from BP Amoco Polymers, Inc.

ICP: Impact-modified propylene copolymer, obtained as SG 702 copolymer from Montell.

HDPE: High density polyethylene, injection molding grade, density=0.953, Ml=20, produced by Union Carbide.

Wood: 40 mesh pine wood flour.

Maleated PP: Maleated homopolypropylene modifier, Ml=110, determined at 190° C. and 2.16 Kg, obtained as Polybond 3200 modifier from Uniroyal Chemical.

Maleated PE: Maleated polyethylene modifier, Ml=24, determined at 190° C. and 2.16 Kg, obtained as Polybond 3109 modifier, from Uniroyal Chemical.

Standard ASTM test specimens for each of the compounded materials were molded on a 75 ton New Britain injection molding machine using front and rear zone temperatures of 200° C. and 190° C. respectively. The injection rate was 5 mm/sec, and the mold temperature was 60° C.

Tensile testing (Tensile Modulus, Tens Mod; ultimate tensile strength, U; and elongation at break, E brk) was carried out in accordance with ASTM-D638; Heat deflection temperature (HDT) was determined in accordance with ASTM-D638, at a stress level of 264 psi; Izod impact strength was measured in accordance with ASTM-D256; Flexural strength (Flex Str) and flexural modulus (Flex Mod) were measured following the procedures of ASTM-D790. Specimens were tested dry-as-molded, except for those identified as conditioned by immersion in water for comparisons based on change in selected physical properties, and for water uptake determination.

Tensile creep measurements were performed at 23° C. and 1000 psi (7 MPa), and at 60° C. and 500 psi (3.5 MPa), for times up to 1000 hours or until rupture, whichever came first. Specimens were tested dry-as-molded, except for those identified as conditioned by immersion in water. Specimens soaked in water for over 5 mo. were also tested, at 23° C. and 750 psi.

### Examples 1-2

Formulations according to the invention comprising wood fiber, crystalline polypropylene and maleated polypropylene were prepared by dry blending the components, then extrusion compounding and pelletizing the mixture according to common practice. The pelletized compositions were then molded to provide standard test specimens and tested as described above. The compositions and property data are summarized in Table I, below.

### Comparison Examples C-1-C-3

Compositions comprising wood fiber and other olefin polymers were prepared and similarly molded to provide comparison examples. The compositions and property data are included in Table I, below.

TABLE I

| | Ex. No.: | 1 | 2 | C-1 | C-2 | C-3 |
|---|---|---|---|---|---|---|
| | Resin: | CPP-1 | CPP-2 | HPP | ICP | HDPE |
| | wt. % | 39 | 39 | 40 | 40 | 50 |
| Wood | wt. % | 60 | 60 | 60 | 60 | 50 |
| Male- | wt. % | 1 | 1 | 0 | 0 | 0 |
| ated PP | | | | | | |

Properties¹

| | | | | | | |
|---|---|---|---|---|---|---|
| Flex | Kpsi | 863 | 809 | 713 | 646 | 437 |
| Mod | | | | | | |
| Flex | psi | 8,700 | 8,000 | 5,700 | 4,100 | 3,800 |
| Str | | | | | | |
| Tens | Kpsi | 914 | 809 | 669 | 582 | 399 |
| Mod | | | | | | |
| U | psi | 5,100 | 4,500 | 3,100 | 2,300 | 2,400 |
| E, | % | 1 | 0.9 | 1.2 | 1 | 1.6 |
| brk | | | | | | |
| U, | psi | 3,300 | 2,850 | 1,650 | 1,200 | 981 |
| 60° C., | | | | | | |
| E brk | % | 1.5 | 1.3 | 2.9 | 1.5 | 3.7 |
| 60° C. | | | | | | |
| HDT, | ° C. | 127 | 120 | 98 | 97 | 73 |
| 264 psi | | | | | | |
| ²CLTE | | | | | | |
| MD | 10⁻⁶ m/m° C. | 33.4 | 12.7 | 29.9 | 26.1 | 45.3 |
| TD | 10⁻⁶ m/m° C. | 114 | 102 | 87.8 | 122 | 165 |
| Rock- | R | 72.1 | 62.5 | 34.8 | n.d.³ | n.d.³ |
| well | | | | | | |

Notes:
¹See text for test methods; mechanical properties determined at room temperature unless otherwise noted.
²Coefficient of linear thermal expansion, over the range 40-100° C.; MD = machine direction, TD = transverse direction.
³n.d. = not determined; hardness was below “R” scale.

It will be apparent that compositions comprising highly crystalline, high tacticity propylene polymer, Examples 1 and 2, exhibit better rigidity as shown by high modulus and by greater flexural and tensile strengths than found for prior art formulations based on polyethylene, Comparison Example C-3, and for those based on impact modified polypropylene, Comparison Example C-2. The rigidity and strength properties are also significantly improved over those for formulations comprising homopolypropylene, Comparison Example C-1.

### Examples 3-9

Formulations with reduced levels of wood fiber and varied levels of maleated PP were prepared by dry blending the pelletized wood-filled resins of Example 1 with additional CPP-1 crystalline polypropylene resin and Polybond 3200 maleated PP. The blends were molded to provide test specimens and tested as described above. The compositions and properties are summarized in Table II, below.

TABLE II

| | Ex. No.: | 1 | 3 | 4 | 5 | 6 | 7 | 8 | 9 |
|---|---|---|---|---|---|---|---|---|---|
| CPP-1 Resin | wt. % | 39 | 37.8 | 37.2 | 58.4 | 57.9 | 55.4 | 78.4 | 77.5 |
| Maleated PP | wt. % | 1 | 2.5 | 4 | 1 | 2.5 | 4 | 1 | 2.5 |
| Wood | wt. % | 60 | 59.7 | 58.8 | 40.6 | 40.6 | 40.6 | 20.6 | 20.0 |

Properties¹

| | | | | | | | | | |
|---|---|---|---|---|---|---|---|---|---|
| Flex Mod | Kpsi | 863 | 839 | 838 | 612 | 609 | 611 | 425 | 412 |
| Flex Str | psi | 8,700 | 9,400 | 9,700 | 8,900 | 9,100 | 9,200 | 8,600 | 8,600 |
| Tens Mod | Kpsi | 914 | 1,030 | 1,010 | 792 | 770 | 785 | 541 | 549 |
| U | psi | 5,100 | 5,600 | 5,850 | 5,400 | 5,600 | 5,700 | 5,150 | 5,200 |
| E, brk | % | 1 | 1.2 | 1.3 | 1.9 | 1.8 | 1.9 | 4.8 | 4.9 |
| HDT, 264 psi | ° C. | 127 | 131 | 132 | 120 | 112 | 115 | 89 | 90 |

Notes:
¹See text for test methods; mechanical properties determined at room temperature.

### Comparison Examples C-4 through C-9

Additional comparison formulations comprising homopolypropylene were prepared by dry blending the pelletized wood-filled resins of Comparison Example C-1 with Polybond 3200 maleated PP and additional HPP* crystalline polypropylene resin. The formulations were then molded and tested as described above. The compositions are summarized in Table III, below.

TABLE III

| | Ex. | | | | | | |
|---|---|---|---|---|---|---|---|
| | No.: | C-4 | C-5 | C-6 | C-7 | C-8 | C-9 |
| HPP | wt. % | 39.6 | 39.0 | 38.4 | 59.0 | 57.5 | 79.0 |
| Resin² | | | | | | | |
| Male- | wt. % | 1 | 2.5 | 4 | 1 | 2.5 | 1 |
| ated | | | | | | | |
| PP | | | | | | | |
| Wood | wt. % | 59.4 | 58.5 | 57.6 | 40.0 | 40.0 | 20.0 |

Properties¹

| | | | | | | | |
|---|---|---|---|---|---|---|---|
| Flex | Kpsi | 732 | 751 | 743 | 534 | 553 | 371 |
| Mod | | | | | | | |
| Flex | psi | 6,300 | 7,200 | 7,900 | 7,800 | 8,300 | 7,800 |
| Str | | | | | | | |
| Tens | Kpsi | 855 | 931 | 879 | 624 | 637 | 446 |
| Mod | | | | | | | |
| U | psi | 3,300 | 4,000 | 4,700 | 4,500 | 4,800 | 4,500 |
| E, | % | 1.1 | 1.1 | 1.3 | 2.5 | 2.0 | 5.3 |
| brk | | | | | | | |
| HDT, | ° C. | 105 | 113 | 115 | 102 | 104 | 83 |
| 264 | | | | | | | |
| psi | | | | | | | |

Notes:
¹See text for test methods; mechanical properties determined at room temperature.
²Blends of C-7-C-11 comprise HPP and HPP*.

### Comparison Examples C-10 through C-15

Additional comparison formulations comprising impact propylene copolymer resin were prepared by dry blending the pelletized wood-filled resins of Comparison Example C-2 with Polybond 3200 maleated PP and additional ICP* impact propylene copolymer resin. The formulations were then molded and tested as described above. The compositions are summarized in Table IV, below.

TABLE IV

| | Ex. | | | | | | |
|---|---|---|---|---|---|---|---|
| | No.: | C-10 | C-11 | C-12 | C-13 | C-14 | C-15 |
| ICP | wt. % | 39.6 | 39.0 | 38.4 | 59.0 | 57.5 | 79.0 |
| Resin² | | | | | | | |
| Male- | wt. % | 1 | 2.5 | 4 | 1 | 2.5 | 1 |
| ated | | | | | | | |
| PP | | | | | | | |
| Wood | wt. % | 59.4 | 58.5 | 57.6 | 40.0 | 40.0 | 20.0 |

Properties¹

| | | | | | | | |
|---|---|---|---|---|---|---|---|
| Flex | Kpsi | 683 | 676 | 675 | 445 | 432 | 235 |
| Mod | | | | | | | |
| Flex | psi | 5,100 | 5,600 | 6,100 | 5,500 | 6,000 | 4,800 |
| Str | | | | | | | |
| Tens | Kpsi | 897 | 795 | 846 | 592 | 538 | 309 |
| Mod | | | | | | | |
| U | psi | 2,800 | 3,200 | 3,600 | 3,100 | 3,350 | 2,600 |
| E, | % | 1.1 | 1.2 | 1.3 | 2.7 | 3.1 | 9.9 |
| brk | | | | | | | |
| HDT, | ° C. | 106 | 110 | 113 | 92 | 94 | — |
| 264 | | | | | | | |
| psi | | | | | | | |

Notes:
¹See text for test methods; mechanical properties determined at room temperature.
²Blends of C-13-C-15 comprise ICP and ICP*.

It will be apparent from a comparison of the modulus and strength properties of formulations according to the invention, presented in Table II, with those of the Comparison Examples, presented in Tables III and IV, that compositions comprising highly crystalline, high tacticity polypropylene and wood fiber exhibit an excellent balance of properties over a wide range of fiber loading. Compositions containing as little as 20 wt. % filler, Examples 8 and 9, will be seen to have higher modulus and greater strength than any of the formulations based on polyethylene or impact modified polypropylene, Table IV. Moreover, although the strength properties of formulations based on homopolypropylene, Table III, approach those of the invented formulations, the latter formulations have significantly greater strength and rigidity when compared on the same filler and additive basis.

As noted above, for outdoor deck application during the summer or in southern climates, the high temperature properties of the formulation are very important. Spans constructed using decking having low tensile and flexural properties require more structural support members in order to withstand loading at elevated temperatures without sagging or bending. The Heat Deflection Temperature (HDT) values for all of the CPP highly crystalline high tacticity polypropylene-based formulations of the invention are seen to be significantly higher than those of the prior art HDPE-and ICP-based materials. CPP-based materials also exhibit a significant boost in HDT relative to those comprising HPP homopolypropylene.

The high temperature (60° C.) tensile strength values for the different polyolefin formulations at the highest wood fiber level, summarized in Table I, demonstrate a substantial improvement in strength for the CPP-based formulations of this invention. At 60° C., the tensile strengths for the 60% wood-filled CPP resins, Examples 1 and 2, are almost twice that of the 60% filled HPP, and over three times that of the 50% filled HDPE formulation.

An important consideration for outdoor applications is the effect of moisture on properties. Molded bars of various 40% wood filled materials were immersed in water for 30 days, and the weight gain and flexural modulus of the bars were measured. The weight gain data and mechanical property data are summarized in the following Tables V and VI.

TABLE V

| | Ex. No.: | 1 | 3 | 5 | 6 |
|---|---|---|---|---|---|
| CPP-1 | wt. % | 39 | 37.8 | 58.4 | 57.9 |
| Maleated PP | wt. % | 1 | 2.5 | 1 | 2.5 |
| Wood | wt. % | 60 | 59.7 | 40.6 | 40.6 |
| Wt. Gain | | | | | |
| 7 days | % | 4.0 | 3.9 | 1.1 | 0.7 |
| 31 days | % | 12.8 | 12.5 | 3.5 | 2.6 |
| Flex Mod | | | | | |
| initial | psi | 863 | 839 | 612 | 609 |
| 7 days | psi | 694 | 662 | 581 | 586 |
| 31 days | psi | 420 | 420 | 490 | 500 |
| Flex Str | | | | | |
| initial | Kpsi | 8,700 | 9,400 | 8,900 | 9,100 |
| 7 days | Kpsi | 7,900 | 8,250 | 8,550 | 8,930 |
| 31 days | Kpsi | 5,900 | 6,050 | 7,900 | 8,200 |
| U | | | | | |
| initial | psi | 5,100 | 5,600 | 5,400 | 5,600 |
| 7 days | psi | 4,800 | 5,300 | 5,400 | 5,600 |
| 31 days | psi | 3,800 | 4,200 | 5,100 | 5,250 |
| E, brk | | | | | |
| initial | % | 1 | 1.2 | 1.9 | 1.8 |
| 7 days | % | 1.4 | 1.4 | 2.0 | 2.1 |
| 31 days | % | 2.4 | 2.3 | 2.3 | 2.2 |

Notes:
¹See text for test methods; mechanical properties determined at room temperature.

TABLE VI

| | Ex. No.: | C-4 | C-5 | C-7 | C-8 | C-16 | C-17 | C-18 |
|---|---|---|---|---|---|---|---|---|
| Resin: | | HPP | HPP | HPP² | HPP² | HDPE | HDPE | HDPE |
| | wt. % | 39.6 | 39.0 | 59.0 | 57.5 | 49.5 | 59.0 | 57.5 |
| Maleated PP | wt. % | 1 | 2.5 | 1 | 2.5 | 1 | 1 | 2.5 |
| Wood | wt. % | 59.4 | 58.5 | 40.0 | 40.0 | 49.5 | 40.0 | 40.0 |
| Wt. Gain | | | | | | | | |
| 7 days | % | 5.3 | 4.1 | 1.0 | 1.0 | 5.0 | 1.8 | 1.7 |
| 31 days | % | 13.1 | 12.3 | 3.1 | 3.2 | 13.1 | 4.2 | 4.2 |
| Flex Mod | | | | | | | | |
| initial | psi | 732 | 751 | 534 | 553 | 425 | 337 | 352 |
| 7 days | psi | 498 | 548 | 506 | 528 | 307 | 317 | 340 |
| 31 days | psi | 305 | 353 | 437 | 456 | 202 | 234 | 268 |
| Flex Str | | | | | | | | |
| initial | Kpsi | 6,300 | 7,200 | 7,800 | 8,300 | 3,900 | 4,250 | 4,600 |
| 7 days | Kpsi | 5,200 | 6,300 | 7,500 | 8,100 | 3,600 | 4,300 | 4,700 |
| 31 days | Kpsi | 4,000 | 4,700 | 6,900 | 7,400 | 2,700 | 3,700 | 4,200 |
| U | | | | | | | | |
| initial | psi | 3,300 | 4,000 | 4,500 | 4,800 | 2,600 | 2,700 | 2,900 |
| 7 days | psi | 3,350 | 3,800 | 4,600 | 4,900 | 2,500 | 2,900 | 3,100 |
| 31 days | psi | 2,400 | 3,000 | 4,400 | 4,500 | 1,900 | 2,800 | 2,900 |
| E, brk | | | | | | | | |
| initial | % | 1.1 | 1.1 | 2.5 | 2.0 | 1.8 | 2.9 | 3.0 |
| 7 days | % | 1.65 | 1.5 | 2.4 | 2.4 | 1.8 | 2.4 | 2.7 |
| 31 days | % | 2.5 | 2.4 | 2.5 | 2.3 | 2.0 | 2.5 | 2.8 |

Notes:
¹See text for test methods; mechanical properties determined at room temperature.
²Blend comprises HPP and HPP*.

The prior art wood fiber-filled HDPE formulations, Comparison Examples C-16 through C-18, absorbed more water than those based on propylene homopolymer or on crystalline high tacticity propylene polymers when compared at equivalent levels of maleated polypropylene additive.

It will be apparent that, when compared at equivalent levels of maleated polypropylene additive, the wood fiber-filled materials according to the invention comprising CPP crystalline high tacticity propylene polymer (Table V) better retain the desirable stiffness characteristics and remain stronger after extended soaking in water than do either wood fiber-filled homopolypropylene formulations or the prior art wood fiber-filled HDPE formulations, summarized in Table VI. Indeed, after 31 days water immersion, the strength and flexural properties of the invented formulations are higher than the initial properties of the prior art HDPE-based formulations prior to soaking; see Comparison Examples C-16 through C-18.

Another important design consideration in the use of wood filled polyolefins in load bearing applications is the creep performance. The creep behavior of formulations at high wood fiber loading, measured in tension at 23° C. and 1000 psi (7 MPa) and at 60° C. and 500 psi (3.5 MPa), are summarized in the following Table VII together with tensile properties measured at the same temperatures.

TABLE VII

| | Ex. No.: | 1 | 2 | C-1 | C-2 | C-3 |
|---|---|---|---|---|---|---|
| | Resin: | CPP-1 | CPP-2 | HPP | ICP | HDPE |
| | wt. % | 39 | 39 | 40 | 40 | 50 |
| Wood | wt. % | 60 | 60 | 60 | 60 | 50 |
| Maleated PP | wt. % | 1 | 1 | 0 | 0 | 0 |

Properties¹

| | | | | | | |
|---|---|---|---|---|---|---|
| U, RT | psi | 5,090 | 4,460 | 3,090 | 2,295 | 2,370 |
| U, 60° C. | psi | 3,330 | 2,850 | 1,650 | 1,240 | 981 |
| Max Creep, RT | % | 0.28 | 0.30 | 0.48 | fail | fail |
| | | | | | (0.40) | (0.48) |
| Max Creep, 60° C. | % | 0.18 | 0.23 | 0.33 | fail | fail |
| | | | | | (0.25) | (0.63) |

Notes:
¹See text for test methods.

Prior art HDPE-based formulations, Comparison Example C-3, exhibit the highest level of creep deformation as a function of time, and fail by creep rupture at both temperatures. The HPP formulations of Comparison Example C-1 and ICP formulations of Comparison Example C-2 also undergo substantially greater creep deformation than the invented formulations comprising highly crystalline, high tacticity polypropylene-based (CPP), Examples 1 and 2. Indeed, 60% filled ICP formulations fail through creep rupture at both test temperatures at relatively short test times, and the ultimate tensile strength (U) values at both temperatures are considerably lower.

Tensile creep behavior of water-soaked specimens comprising formulations with 40 wt. % wood fiber loading was evaluated. The specimens were conditioned by water soak at room temperature for five months, then maintained under moist conditions during testing. Creep properties and tensile properties, measured in tension at room temperature and 750 psi stress (5.25 MPa), are summarized in the following Table VIII.

TABLE VIII

| Ex. No.: | | 5 | C-7 | C-17 |
|---|---|---|---|---|
| | Resin: | CPP-1 | HPP | HDPE |
| | wt. % | 58.4 | 59.0 | 59.0 |
| Wood | wt. % | 40.6 | 40.0 | 40.0 |
| Maleated PP | wt % | 1 | 1 | 1 |
| Water content, | % | 8.18 | 8.89 | 8.66 |
| 3800 hr. soak | | | | |
| Max Creep, RT | % | 0.875 | 1.25 | fail |
| | | | | (2.575) |
| | hours | 985 | 985 | 191 |
| | | | | (fail) |
| Tens Mod, 49° C. | Kpsi | 246 | 232 | 149 |
| U, 49° C. | psi | 3210 | 2640 | 1300 |
| E, brk, 49° C. | % | 5.5 | 5.3 | 6.7 |

Notes: 1. See text for test methods; Max Creep = strain % at 985 hours or (at time of failure).

As noted above for dry specimens, compositions according to the invention exhibit substantially better creep characteristics than formulations based on homopolypropylene HPP, even after 5 months of soaking in water. Prior art HDPE-based formulations sustain the applied stress for only a brief test period before undergoing rupture failure. Compare creep properties for Example 5 with Comparison Example C-17.

After 5 months of soaking in water, the compositions of this invention also exhibit substantial improvement in elevated temperature tensile properties compared with prior art HDPE-based formulations or homopolypropylene-based formulations.

Compare Example 3 with Comparison Example C-7 and Comparison Example C-17.

Examples 10 and 11: Additional examples based on CPP-2 highly crystalline, high tacticity polypropylene were prepared and evaluated. The formulations and property data are summarized in the following Table IX.

TABLE IX

| Ex. No.: | | 2 | 10- | 11 |
|---|---|---|---|---|
| | Resin: | CPP-2 | CPP-2 | CPP-2 |
| | wt. % | 39 | 58.4 | 78.4 |
| Maleated PP | wt. % | 1 | 1 | 1 |
| Wood | wt. % | 60 | 40.6 | 20.0 |
| Flex Mod | Kpsi | 809 | 593 | 379 |
| Flex Str | psi | 8,000 | 8,600 | 8,250 |
| Tens Mod | Kpsi | 809 | 716 | 464 |
| U | psi | 4,500 | 5,100 | 4,950 |
| E, brk | % | 0.9 | 1.6 | 3.0 |
| HDT, 264 psi | ° C. | 120 | 114 | 89 |

Notes: 1. See text for test methods; mechanical properties determined at room temperature.

The invention will thus be seen to be directed to improved cellulose fiber-filled polyolefin formulations suitable for use in outdoor building applications and decking where a good balance of strength properties is required to be maintained even at elevated temperatures and on exposure to wet environments. The compositions of this invention will comprise highly crystalline, high tacticity propylene polymer and cellulosic fiber, preferably including a compatibilizing aid such as a functionalized olefin polymer. Preferred compositions include those comprising from about 85 to about 30 wt. % of the highly crystalline, high tacticity propylene polymer component, preferably with an nmr tacticity index of at least 94 and as great as 100, more preferably from about 94 to about 97; from about 15 to about 70 wt. % cellulose fiber, preferably wood fiber; and from about 0.5 to about 10 wt. %, preferably from about 1 to about 6 wt. % functionalized olefin polymer, preferably maleated polypropylene.

Highly crystalline, high tacticity propylene polymer having an nmr tacticity index of at least 94 and a broad molecular weight distribution, Mw/Mn, of from about 7 to about 15, preferably from about 8 to about 12, will be found particularly suitable for use in the practice of this invention.

Any of the melt extrusion and molding processes commonly employed in the art with filled resins may be used with the invented compositions to provide building components such as, for example, planks, boards, decking, profile-extruded trim, cladding and the like. The extruded components are conveniently produced to any length in nominal lumber sections and dimensions, for example, as 5/4 tongue-and-groove decking with nominal 2″ to 6″ and greater widths, boards in nominal thickness of from about ½″ to about 2″ and in nominal widths of from 1″ to 12″ and greater, wainscoting and the like. Dowel, railing components, baluster and trim, as well as cladding and siding for external building use, may also be produced from the compositions of this invention by profile extrusion. Such components are readily fabricated with the same tools used to work wood lumber, and may be attached to supporting members using nails or screws. Components may also be pegged or bolted together, or fastened using clips or fasteners. Caulks and adhesives suitable for use with these materials also may be devised.

The invention thus may be further described as directed to building components such as, for example, extruded decking components having improved moisture resistance comprising the highly crystalline, high tacticity polypropylene formulations set forth herein. The invention may also viewed as directed to a method for making building and decking components having excellent creep resistance, particularly at elevated temperatures, preferably components having a 1000 hr. creep deformation of less than about 0.3% total strain measured in tension at 60° C. and 3.5 MPa.

Building components according to the invention possess a highly desirable balance of strength properties and are particularly attractive for their strength properties at elevated temperatures. These materials retain useful stiffness and strength properties upon long term exposure to moisture, conditions where prior art filled HDPE and ICP materials undergo catastrophic failure or become reduced in strength substantially below the level needed for continued use in many applications.

Inasmuch as the compositions of this invention are particularly resistant to rot and insect damage, extruded lumber and profile may also find use where ground contact is contemplated, for example, in garden landscaping. Rot-and termite-resistant extruded lumber according to the invention may be useful for garden engineering, particularly where structural loads are not great, such as for constructing decorative trellis and fencing, as soil retainers and pre-formed edging timbers and the like. Highly attractive benches and outdoor furniture, as well as playground structures, may be fabricated in part using lumber and profile extruded in a wide variety of colors and with attractive surface appearances such as emulated wood grain as well as with slip-resistant surface embossments and the like. As such, it is desirable to manufacture building components having a standard lumber profile. As used herein, the term “standard lumber profile” means having the finished dimensions and shape of lumber typically available from lumber dealers located in the relevant geographic region (i.e. having a cross section of about 1 5/8 by 3 1/2 inches for a common 2×4″ framing stud in the United States.)

Compositions according to this invention may further contain such colorants, pigments, flame retardants, thermal and light stabilizers, lubricants, processing aids and the like as may be desired according to common practice in the art employed for the compounding and fabrication of filled resins. The invented compositions may also be extended to reduce cost by further compounding with compatible, less expensive resins, for example, other polyolefin resins such as polypropylene resins with a lower degree of crystallinity, or the like. Inasmuch as such further compounding may reduce modulus and strength properties, the amount of such additional polyolefin resin employed in formulating such blends will be selected to afford a balance of properties suited to the envisioned use.

While the invention has been illustrated by means of specific embodiments, these are not intended to be limiting. Further additions and modifications will be readily apparent to those skilled in the art, and such modifications and additions, and compositions, formulations and articles embodying them, are contemplated to lie within the scope of the invention as defined and set forth in the following claims.

We claim:

1. A composition comprising highly crystalline propylene polymer having an NMR tacticity index of at least 94 and a cellulosic fiber.

2. The composition of claim 1 further including a compatibilizing aid in an amount sufficient to improve compatibility between polymeric materials and said fiber.

3. The composition of claim 2 wherein said compatibilizing aid is a functionalized olefin polymer.

4. The composition of claim 1 wherein said crystalline propylene polymer has an MWD (Mw/Mn) of from about 7 to about 15.

5. The composition of claim 1 comprising from about 30 to about 85 wt. % said crystalline propylene polymer.

6. The composition of claim 1 wherein said fiber is wood fiber.

7. The composition of claim 1 comprising from about 15 to about 70 wt. % said fiber.

8. The composition of claim 3 comprising from about 0.3 to about 12 wt. % said functionalized olefin polymer.

9. The composition of claim 3 wherein said functionalized olefin polymer is maleated polypropylene.

10. A composition comprising highly crystalline propylene polymer having an NMR tacticity index of at least 94, from about 0.3 to about 12 wt. % of a functionalized olefin polymer and a cellulosic fiber.

11. The composition of claim 10 wherein MWD (Mw/Mn) of said crystalline propylene polymer is in the range of from about 7 to about 15.

12. The composition of claim 10 wherein said crystalline propylene polymer has an NMR tacticity index of from about 94 to about 97.

13. The composition of claim 10 wherein said crystalline propylene polymer has an NMR tacticity index of from about 94 to about 97 and a melt flow rate (MFR) of from about 5 to about 50.

14. The composition of claim 10 comprising from about 30 to about 85 wt.% said crystalline propylene polymer.

15. The composition of claim 10 comprising from about 40 to about 70 wt. % said crystalline propylene polymer.

16. The composition of claim 10 wherein said crystalline propylene polymer is a nucleated propylene polymer comprising from about 0.01 to about 0.5 wt. % crystallization nucleating agent.

17. The composition of claim 10 wherein said crystalline propylene polymer consists essentially of a nucleated crystalline propylene polymer having an NMR tacticity index of from about 94 to about 97, an MWD (Mw/Mn) of from about 7 to about 15 and a melt flow rate (MFR) of from about 5 to about 50.

18. The composition of claim 10 comprising from about 1 to about 6 wt. % said functionalized olefin polymer.

19. The composition of claim 10 wherein said functionalized olefin polymer is maleated polypropylene.

20. The composition of claim 10 wherein said said functionalized olefin polymer is maleated polypropylene having a maleation level of from about 0.4 to about 2 wt. % and a melt index (Ml) of from about 1 to about 500 g/10 min.

21. The composition of claim 10 comprising from about 20 to about 60 wt. % wood fiber.

22. A building component comprising from about 30 to about 85 wt. % highly crystalline propylene polymer having an NMR tacticity index of at least 94, a melt flow rate (MFR) of from about 5 to about 50 g/10 min and Mw/Mn in the range of from about 7 to about 15 and from about 15 to about 70 wt. % wood fiber.

23. The building component of claim 22 further comprising from about 0.5 to about 10 wt. % maleated polypropylene having a maleation level of from about 0.4 to about 2 wt. %.

24. The building component of claim 22 wherein said component is extruded.

25. The extruded component of claim 24 in the form of 5/4 tongue-and-groove decking having a nominal width of from 2″ to about 6″.

26. The extruded component of claim 24 having a standard lumber profile with nominal thickness of from about ½″ to about 2″.

27. The extruded component of claim 24 having a standard lumber profile with nominal width of from about 1″ to about 12″.

28. The extruded component of claim 24 in the form of a profile extrusion useful as railing, baluster, trim, cladding or siding.

29. An extruded decking component having improved resistance to moisture comprising from about 30 to about 85 wt. % highly crystalline propylene polymer having an NMR tacticity index of at least 94, a melt flow rate (MFR) of from about 5 to about 50 and Mw/Mn in the range of from about 7 to about 15; from about 0.5 to about 10 wt. % maleated polypropylene having a maleation level of from about 0.4 to about 2 wt. %; and from about 15 to about 70 wt. % cellulosic fiber.

30. The component of claim 29 wherein said fiber consists essentially of wood fiber.

31. A decking component comprising wood fiber-filled, highly crystalline propylene polymer having an NMR tacticity index of at least 94, said decking component having a 1000 hour creep deformation measured in tension at 60° C. and 3.5 MPa of less than about 0.30% total strain.

32. The decking component of claim 31 wherein said crystalline propylene polymer has an NMR tacticity index of from about 94 to about 97, an Mw/Mn in the range of from about 7 to about 15, and a melt flow rate (MFR) of from about 5 to about 50.
